(19) United States
(12) Patent Application Publication
(10) Pub. No.: US 2025/0178602 A1
(43) Pub. Date: Jun. 5, 2025

(54) METHOD FOR DETERMINING A CRITICALITY OF THE EVASIVE BEHAVIOR OF AN AT LEAST PARTIALLY AUTOMATED VEHICLE

(71) Applicant: Robert Bosch GmbH, Stuttgart (DE)

(72) Inventors: Tobias Bezner, Stuttgart (DE); Uesame Uzhan Kocaman, Aachen (DE)

(21) Appl. No.: 18/950,966

(22) Filed: Nov. 18, 2024

(30) Foreign Application Priority Data
Nov. 30, 2023 (DE) 10 2023 211 978.1

(51) Int. Cl. B60W 30/09; B60W 50/00; B60W 60/00

(52) U.S. Cl. CPC B60W 30/09; B60W 50/0098; B60W 60/001; B60W 2050/0028; B60W 2510/18; B60W 2510/20; B60W 2720/106; B60W 2720/125

(57) ABSTRACT

A method for determining a criticality of the evasive behavior of an at least partially automated vehicle moving at an instantaneous velocity. The method includes: calculating a plurality of evasive trajectories of the vehicle with respect to a referenced collision object by combining different longitudinal accelerations with different lateral accelerations; determining an optimal trajectory, in which a minimum distance between the vehicle and the collision object is maximum, from the plurality of evasive trajectories; determining a critical acceleration vector of an associated critical trajectory in which the minimum distance reaches a near-collision limit range; and determining a criticality of the optimal trajectory on the basis of the critical acceleration vector and an optimal acceleration vector associated with the optimal trajectory.

### CROSS REFERENCE

The present application claims the benefit under 35 U.S.C. § 119 of German Patent Application No. DE 10 2023 211 978.1 filed on Nov. 30, 2023, which is expressly incorporated herein by reference in its entirety.

### FIELD

The present disclosure relates to driver assistance systems and driver assistance methods with at least partially automated driving functions. In particular, a computer-implemented method for determining a criticality of the evasive behavior of an at least partially automated vehicle is disclosed.

### BACKGROUND INFORMATION

Various driver assistance systems for warning drivers and for steering or braking intervention or corresponding driver warning in dangerous situations are described in the related art. In the development of driver assistance systems into partially automated, automated, or highly automated driving systems, various approaches are pursued to avoid collisions or reduce the consequences of collisions. In principle, in order to avoid collisions, such driving systems can predict and/or carry out automated evasive maneuvers, which comprise mere braking, mere steering, or combined braking and steering relative to a collision object detected, for example, through sensor data. By planning the trajectory of the vehicle relative to the collision object, it can be determined whether an evasive maneuver is necessary and/or possible. Of great importance in such driving systems is the assessment of the evasive behavior with respect to safety. In particular, such driving systems must be secured against risks (i.e., validated) before they are introduced into the market. A safety assessment is also relevant to the optimal selection of an evasive maneuver with regard to minimal or at least reduced risk. Various criticality metrics are available for this purpose, which make it possible to quantitatively assess the driving behavior or evasive maneuvers. In principle, a distinction can be made between subcritical cases in which a collision can be avoided and critical cases in which a collision is unavoidable. In particular, criticality metrics should reliably assess driving situations at both slow and high velocities.

The present invention addresses the problem of more reliably providing a quantitative assessment of evasive behavior of an at least partially automated vehicle.

### SUMMARY

A first general aspect of the present invention relates to a computer-implemented method for determining a criticality of the evasive behavior of an at least partially automated vehicle, wherein the at least partially automated vehicle is moving at an instantaneous velocity. According to an example embodiment of the present invention, the method comprises calculating a plurality of evasive trajectories of the vehicle with respect to a referenced collision object by combining different longitudinal accelerations with different lateral accelerations. The method furthermore comprises determining an optimal trajectory, in which a minimum distance between the vehicle and the collision object is maximum, from the plurality of evasive trajectories. The method furthermore comprises determining a critical acceleration vector of an associated critical trajectory in which the minimum distance reaches a near-collision limit range. The method furthermore comprises determining a criticality of the optimal trajectory on the basis of the critical acceleration vector and an optimal acceleration vector associated with the optimal trajectory. In embodiments, determining the critical acceleration vector may comprise reducing the magnitude of the optimal acceleration vector to the critical acceleration vector at which the minimum distance reaches the near-collision limit range. In embodiments, the criticality of the optimal trajectory may be determined by forming the ratio of the magnitude of the critical acceleration vector to the magnitude of the optimal acceleration vector.

A second general aspect of the present invention relates to a computer system designed to perform the computer-implemented method for determining a criticality of the evasive behavior of an at least partially automated vehicle according to the first general aspect (or an embodiment thereof).

A third general aspect of the present invention relates to a computer program comprising commands which, when the computer program is executed by a computer system, cause the computer system to execute the computer-implemented method for determining a criticality of the evasive behavior of an at least partially automated vehicle according to the first general aspect (or an embodiment thereof).

A fourth general aspect of the present invention relates to a computer-readable medium or signal that stores and/or contains the computer program according to the third general aspect (or an embodiment thereof).

A fifth general aspect of the present invention relates to a method for testing and/or securing an at least partially automated driving function system. In the method, the criticality determined by the computer-implemented method according to the first general aspect (or an embodiment thereof) is used as an assessment criterion for the release of the at least partially automated driving function system.

A sixth general aspect of the present invention relates to a method for configuring an at least partially automated driving function system. In the method, the configuration of at least partially automated driving functions, in particular the configuration of rules for evasive maneuvers, is carried out at least on the basis of the criticality determined by the computer-implemented method according to the first general aspect (or an embodiment thereof).

The computer-implemented method according to the first general aspect (or an embodiment thereof) of the present invention can serve to obtain a quantitative assessment of driving behavior, in particular evasive behavior, of an at least partially automated vehicle. In particular, the computer-implemented method can be used to assess various evasive maneuvers with regard to a maximum usable vehicle capability. In other words, the proposed determination of the criticality can be used to assess what proportion of the total vehicle capability must be used to avoid a collision. This makes better comparability of the criticalities in different driving situations possible, in particular driving situations with different instantaneous velocities. In other words, the determined criticalities can be better compared over large velocity ranges than the minimum distances can. This can improve the selection and securing of evasive maneuvers with regard to a collision risk and/or with regard to reducing the consequences of a collision. Accordingly, the proposed method can improve a partially automated driving function. A further advantage of the proposed computer-implemented method is that the quantitative knowledge of the utilized proportion of the total vehicle capability allows an intensity (e.g., braking intensity and/or steering intensity or longitudinal acceleration and/or lateral acceleration) of a driving maneuver, for example an evasive maneuver, to be reduced or increased. This in turn can result in advantages with regard to user satisfaction or with regard to reducing wear and tear.

Some terms are used in the present disclosure in the following way:

A “longitudinal acceleration” can be regarded as the magnitude of acceleration in the longitudinal direction, i.e., in the lengthwise direction of the at least partially automated vehicle under consideration.

A “lateral acceleration” can be regarded as the magnitude of acceleration in the lateral direction, i.e., in the sideways direction of the at least partially automated vehicle under consideration.

An “acceleration vector a” is the resultant of longitudinal acceleration and lateral acceleration.

A “vehicle” can be any device that transports passengers and/or freight. A vehicle can be a motor vehicle (for example a passenger car or a truck), but also a rail vehicle. A vehicle can also be a motorized two-wheeler or three-wheeler. However, floating and flying devices can also be vehicles. Vehicles can be operating or assisted at least partially autonomously.

The term “at least partially automated” includes devices and/or processes that are partially automated, automated, and/or highly automated.

### BRIEF DESCRIPTION OF THE DRAWINGS

FIG. 1 schematically illustrates a method for determining a criticality of the evasive behavior of an at least partially automated vehicle, as well as the use of the determined criticality in a method for testing and/or securing an at least partially automated driving function system, and in a method for configuring an at least partially automated driving function system, according to an example embodiment of the present invention.

FIG. 2A schematically illustrates the determination of an exemplary evasive trajectory by combining a longitudinal acceleration with a lateral acceleration in a maximum friction force model, according to an example embodiment of the present invention.

FIG. 2B schematically illustrates the determination of an exemplary evasive trajectory by combining a longitudinal acceleration with a lateral acceleration in a maximum friction force model, according to an example embodiment of the present invention.

FIG. 3 schematically illustrates an exemplary evasive maneuver of an at least partially automated vehicle, which can avoid a collision object at a distance dmin according to an exemplary evasive trajectory, according to an example embodiment of the present invention.

### DETAILED DESCRIPTION OF EXAMPLE EMBODIMENTS

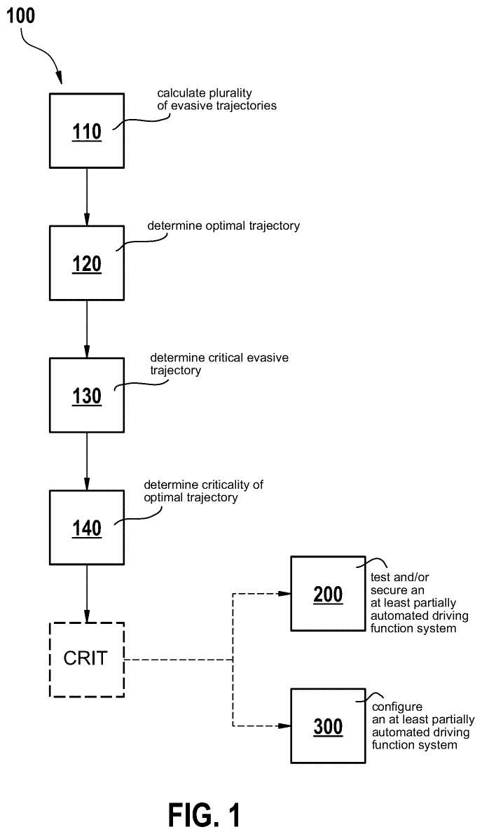

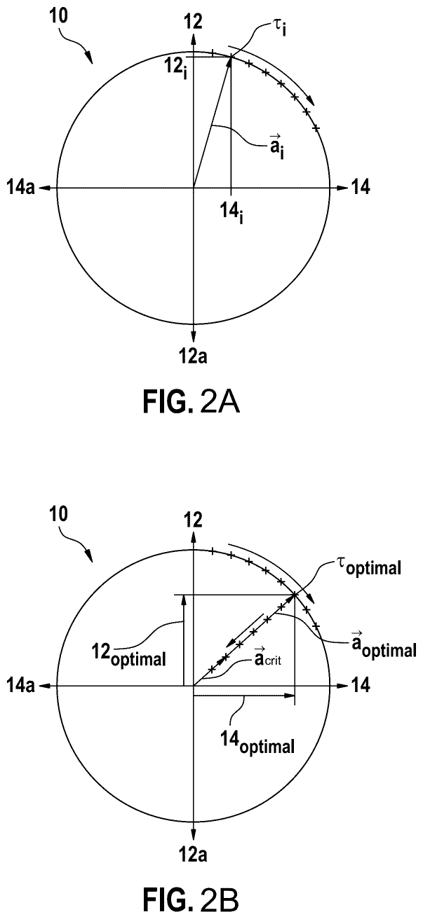

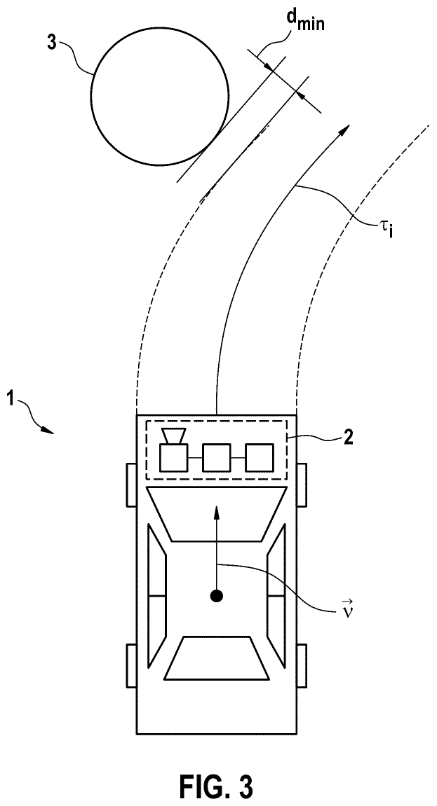

Firstly, the techniques of the present invention are discussed with reference to FIG. 1, FIG. 2A, and FIG. 2B. With reference to FIG. 3, possible results and advantages resulting from the computer-implemented method 100 disclosed here for determining a criticality CRIT of the evasive behavior of an at least partially automated vehicle 1 are discussed.

FIG. 1 is a flow chart showing possible steps of the computer-implemented method 100 for determining a criticality CRIT of the evasive behavior of an at least partially automated vehicle 1, wherein the vehicle 1 is moving at an instantaneous velocity \vec{v}. The computer-implemented method 100 comprises calculating 110 a plurality of evasive trajectories τᵢ of the vehicle with respect to a referenced collision object 3 by combining different longitudinal accelerations 12 with different lateral accelerations 14, 14a. Furthermore, in step 120, an optimal trajectory τₒₚₜᵢₘₐₗ, in which a minimum distance dₘᵢₙ between the vehicle 1 and the collision object 3 is maximum, is determined from the plurality of evasive trajectories τᵢ. The method 100 furthermore comprises determining 130 a critical acceleration vector \vec{a}_{crit} of an associated critical trajectory τ_{crit}, in which the minimum distance (dₘᵢₙ) reaches a near-collision limit range. The method furthermore comprises determining a criticality CRITₒₚₜᵢₘₐₗ of the optimal trajectory τₒₚₜᵢₘₐₗ on the basis of the critical acceleration vector \vec{a}_{crit} and an optimal acceleration vector \vec{a}ₒₚₜᵢₘₐₗ associated with the optimal trajectory τₒₚₜᵢₘₐₗ.

As FIG. 1 furthermore shows, the present disclosure also relates to a method 200 for testing and/or securing an at least partially automated driving function system 2. In the method 200, the criticality CRIT determined by the computer-implemented method 100 is used as an assessment criterion for the release of the at least partially automated driving function system 2.

Furthermore, with reference to FIG. 1, the present disclosure also relates to methods 300 for configuring an at least partially automated driving function system 2. In the method 300, the configuration of at least partially automated driving functions is carried out at least on the basis of the criticality CRIT determined by the computer-implemented method 100. In embodiments, the configuration of at least partially automated driving functions may comprise the configuration of rules for evasive maneuvers. In embodiments, a control unit of the at least partially automated driving function system 2 may be configured at least on the basis of the criticality CRIT determined by the computer-implemented method 100. In embodiments, it is possible to configure a back-end system designed to communicate with the at least partially automated driving function system 2. In embodiments of the method 300, the configuration may comprise loading software into a memory of the at least partially automated driving function system 2. In embodiments, the software may be loaded over-the-air.

Further embodiments of the computer-implemented method 100 are explained below with reference to FIGS. 2A and 2B. FIGS. 2A and 2B show an exemplary methodology for determining the evasive trajectories τᵢ or their associated acceleration vectors \vec{a}ᵢ. In detail, FIGS. 2A and 2B show a maximum friction force model 10. This is a model that takes into account the maximum forces or accelerations that a vehicle can transmit to its environment. In the present example, a circle-of-forces model 10 familiar to a person skilled in the art in the field of road vehicles is used. Accordingly, depending on vehicle specifications and surface specifications, a limit range of maximum transmittable forces or accelerations can be schematically represented by the circle shown. The axis 12, 12a represents longitudinal accelerations 12, 12a. The axis 12 can represent braking accelerations 12 or decelerations or reverse accelerations starting from the origin upward. The axis 12a can represent drive accelerations 12a or forward accelerations starting from the origin downward. The axis 14, 14a represents lateral accelerations 14, 14a, which can be caused, for example, by steering the vehicle 1. The axis 14 can indicate lateral accelerations directed to the right, starting from the origin rightward (for example, by steering to the left). The axis 14a can indicate lateral accelerations directed to the left, starting from the origin leftward (for example, by steering to the right). The representation of right-left accelerations and forward-reverse acceleration explained here by way of example may also be defined alternatively in other embodiments. Essential for the representation is the representation of longitudinal accelerations or longitudinal forces orthogonal to lateral accelerations or lateral forces.

Combining different longitudinal accelerations 12 with different lateral accelerations 14 in step 110 may thus comprise combining maximum usable braking capability with maximum usable steering capability, according to the maximum friction force model 10 shown in FIG. 2A. In other words, the maximum usable vehicle capability with regard to steering and/or braking (i.e., the maximum transmittable friction force) according to the maximum friction force model 10 is determined. The different longitudinal accelerations 12 may be based on different braking intensities. The different lateral accelerations 14 may be based on different steering intensities. Different ratios of longitudinal accelerations 12 and lateral accelerations 14 may be combined by selecting different points along the circle and the resulting magnitudes 12ᵢ and 14ᵢ. This is shown schematically in FIG. 2A by the curved arrow and the crosses on the circle. By way of example, the longitudinal acceleration 12ᵢ and lateral acceleration 14ᵢ are determined for the evasive trajectory τᵢ. The resultant of longitudinal acceleration 12ᵢ and lateral accelerations 14ᵢ forms the acceleration vector \vec{a}ᵢ associated with the corresponding evasive trajectory τᵢ. Using trajectory calculation models known to a person skilled in the art, the trajectory or evasive trajectory τᵢ can be determined on the basis of the instantaneous velocity \vec{v} of the vehicle. In other words, the plurality of evasive trajectories τᵢ can be calculated on the basis of the instantaneous velocity \vec{v} by combining different braking intensities with different steering intensities. The calculation of the plurality of evasive trajectories τᵢ can comprise a calculation of, for example, 2 to 1000, 10 to 500 or 50 to 100, evasive trajectories τᵢ. In embodiments, more than 1000 evasive trajectories τᵢ may also be calculated. Even if only one side of lateral acceleration 14 is shown in the example shown in FIG. 2A, it is also possible in embodiments to take into account lateral accelerations 14a to the other side. By combining different longitudinal accelerations 12 with different lateral accelerations 14, mere braking, mere steering, and values in between can be taken into account. In other words, by combining different longitudinal accelerations 12 with different lateral accelerations 14 according to the maximum friction force model 10, different maximum transmittable acceleration vectors \vec{a}ᵢ. can be formed from a braking vector 12ᵢ and a steering vector 14ᵢ.

As illustrated in FIG. 3, explained in more detail below, the minimum distance dₘᵢₙ between the vehicle 1 and the collision object 3 can be determined for each calculated evasive trajectory τᵢ. In embodiments, the corresponding minimum distances dₘᵢₙ of the plurality of evasive trajectories τᵢ may be compared with one another. The evasive trajectory τᵢ of the plurality of evasive trajectories τᵢ with the largest minimum distance dₘᵢₙ can be selected or determined as the optimal evasive trajectory τₒₚₜᵢₘₐₗ.

FIG. 2B shows an exemplary optimal evasive trajectory τₒₚₜᵢₘₐₗ with the associated optimal acceleration vector \vec{a}ₒₚₜᵢₘₐₗ and corresponding optimal longitudinal acceleration 12ₒₚₜ and optimal lateral acceleration 14ₒₚₜ. As FIG. 2B furthermore shows, determining the critical acceleration vector \vec{a}_{crit} may comprise reducing the magnitude of the optimal acceleration vector \vec{a}ₒₚₜᵢₘₐₗ to the critical acceleration vector \vec{a}_{crit}, at which the minimum distance dₘᵢₙ reaches the near-collision limit range. In embodiments, the magnitude may be reduced step by step, as shown in FIG. 2B by way of example by the arrow along the acceleration vector in the direction of the origin. The minimum distance dₘᵢₙ can be determined for each step. The step-by-step reduction may take place in steps of equal or different sizes. In particular, the magnitude of the optimal acceleration vector \vec{a}ₒₚₜᵢₘₐₗ may be iteratively reduced until the minimum distance dₘᵢₙ reaches the near-collision limit range. In embodiments, the near-collision limit range may be defined by the dₘᵢₙ>0 and dₘᵢₙ≤ϵ. “ϵ” may define a near-collision distance ϵ at which a collision between the vehicle 1 and the collision object 3 is just avoided. In embodiments, the near-collision distance ϵ may be between 1 mm and 1000 mm, preferably between 10 mm and 500 mm, particularly preferably between 50 mm and 100 mm. In particular, the near-collision distance ϵ may also be <1000 mm, <500 mm, <100 mm, <50 mm, <10 mm, or <1 mm.

In embodiments, the criticality CRITₒₚₜᵢₘₐₗ of the optimal trajectory τₒₚₜᵢₘₐₗ may be determined by forming the ratio of the magnitude of the critical acceleration vector \vec{a}_{crit} to the magnitude of the optimal acceleration vector \vec{a}ₒₚₜᵢₘₐₗ. This means that:

$${CRIT}_{optimal} = \frac{\vert {\vec{a}}_{crit} \vert}{\vert {\vec{a}}_{optimal} \vert}$$

The proposed computer-implemented method is in particular advantageous in the use case of subcritical situations, i.e., in situations where a collision can be avoided. The value of CRIT may vary from 0 to 1. The lower the value of the criticality CRIT, the lower the proportion of the maximum usable vehicle capability that is at least necessary to prevent a collision. If the value of \vec{a}_{crit} and thus the value of CRIT is equal to 0, no evasive maneuver is necessary. The higher the value of the criticality CRIT, the greater the proportion of the maximum usable vehicle capability that is at least necessary to prevent a collision.

In the case that none of the calculated evasive trajectories τᵢ results in a minimum distance dₘᵢₙ>0, a collision cannot be prevented. This means that, in such a driving situation, d_{min i}s negative even for the optimal trajectory τₒₚₜᵢₘₐₗ. In a first variant of the computer-implemented method 100, the criticality CRIT may be limited to 1 in such a case. In a second variant of the computer-implemented method 100, the criticality CRIT may also be greater than 1 in such a case. Analogously to the above-described reduction of the magnitude of the optimal acceleration vector \vec{a}ₒₚₜᵢₘₐₗ, the magnitude of the optimal acceleration vector \vec{a}ₒₚₜᵢₘₐₗ in this second variant may be increased to a critical acceleration vector \vec{a}_{crit} for which a critical trajectory (τ_{crit}) in which the minimum distance (dₘᵢₙ) again reaches the near-collision limit range is determined. Even in critical cases in which a collision is unavoidable, a risk assessment can thus be carried out depending on the maximum usable vehicle capability.

In embodiments of the computer-implemented method 100, an associated acceleration vector \vec{a}ᵢ, a critical acceleration vector \vec{a}_{i, crit}, and a corresponding criticality CRITᵢ may be determined for several, in particular all, of the calculated plurality of evasive trajectories τᵢ. Furthermore, an optimized trajectory τ_{optimized} may be determined on the basis of a comparison of the determined criticalities CRITₒₚₜᵢₘₐₗ, CRITᵢ. The trajectory τᵢ of which the criticality value is the lowest may be determined as the optimized trajectory τ_{optimized}. The following may apply to the determined criticalities CRIT analogously to the above explanations:

$${CRIT}_{i} = \frac{\vert {\vec{a}}_{i , crit} \vert}{\vert {\vec{a}}_{i} \vert}$$

In embodiments, the computer-implemented method 100 may comprise an action step for displaying the optimal trajectory τₒₚₜᵢₘₐₗ and/or the criticality CRITₒₚₜᵢₘₐₗ thereof. In embodiments, displaying may comprise an acoustic output, a visual output, and/or a vibratory output. In embodiments, the computer-implemented method 100 may comprise an action step for the autonomous or semi-autonomous adjustment of an evasive maneuver of the at least partially automated vehicle 1 according to the optimal trajectory τₒₚₜᵢₘₐₗ. In embodiments, the determined criticality CRIT, CRITᵢ, CRITₒₚₜᵢₘₐₗ may be used to test and/or secure an at least partially automated driving function system 2 of the at least partially automated vehicle 1. For example, a release may be refused from a certain criticality value, for example from a value of CRIT=0.7 or greater.

In this regard, FIG. 3 schematically shows an at least partially automated vehicle 1 and a referenced collision object 3. The at least partially automated vehicle 1 may be equipped with an at least partially automated driving function system 2. The at least partially automated driving function system 2 may comprise a sensor system and/or obtain sensor data from a sensor system. The sensor system may be designed to record vehicle data and environmental data. For example, the sensor system may comprise long-range and mid-range environmental sensors based, for example, on long-range radar (LRR), lidar, mid-range radar (MRR), short-range radar (SRR), ultrasound, video, or the like. Information about the referenced collision object 3 can be obtained via the sensor system. The at least partially automated driving function system 2 may be designed to perform the computer-implemented method 100 described above. The at least partially automated vehicle 1 moves at an instantaneous velocity \vec{v} in the longitudinal direction (along the arrow \vec{v}). By way of example, FIG. 3 shows a calculated evasive trajectory τᵢ, which can prevent a collision with the collision object 3. It is understood that the collision object 3 or its position may be considered static or dynamic. A person skilled in the art knows various approaches to the dynamic consideration of a collision object. For example, a position or movement (i.e., change in position) of the collision object 3 can be projected into the future. The projection of the movement of the collision object 3 may, for example, be carried out with a constant velocity vector. In other examples, the projection of the movement of the collision object 3 may comprise a change in the velocity vector (e.g., by changing the direction and/or the magnitude of the velocity vector) of the collision object 3, in particular a change toward the trajectory of the vehicle 1. The minimum distance dₘᵢₙ associated with the exemplary evasive trajectory τᵢ is also shown. As described above, the computer-implemented method 100 can be performed during operation of the at least partially automated vehicle 1. For example, the illustrated evasive trajectory τᵢ may correspond to the optimal trajectory τₒₚₜᵢₘₐₗ. The computer-implemented method 100 may cause the at least partially automated vehicle 1 to steer according to the optimal trajectory τₒₚₜᵢₘₐₗ by outputting steering signals and/or braking signals. Alternatively or additionally, a warning and/or a recommendation may be output via a user interface. Alternatively or additionally, the method 100 may be used to test and/or secure an at least partially automated driving function system 2 of the at least partially automated vehicle 1.

Also disclosed is a computer system designed to perform the method 100 for determining a criticality CRIT of the evasive behavior of an at least partially automated vehicle 1 moving at an instantaneous velocity \vec{v}. The computer system can comprise at least one processor and/or at least one working memory. The computer system can furthermore comprise a (non-volatile) memory. In examples, all steps of the method 100 may be performed by the computer system. In some examples, individual steps of the method 100 may be performed by the computer system. Optionally, results of individual method steps that are not performed by the computer system may be received by the computer system. In embodiments, the computer system may be comprised in the at least partially automated driving function system 2 described above.

Also disclosed is a computer program designed to perform the method 100 for determining a criticality CRIT of the evasive behavior of an at least partially automated vehicle 1 moving at an instantaneous velocity \vec{v}. The computer program can be present, for example, in interpretable or in compiled form. For execution, it can (even in parts) be loaded into the RAM of a computer, for example as a bit or byte sequence. In embodiments, the computer program may be loaded into a memory of the at least partially automated driving function system 2 described above.

A computer-readable medium or signal that stores and/or contains the computer program or at least a portion thereof is also disclosed. The medium can comprise, for example, any one of RAM, ROM, EPROM, HDD, SDD, . . . , on/in which the signal is stored.

What is claimed is:

1. A computer-implemented method for determining a criticality of an evasive behavior of an at least partially automated vehicle, wherein the at least partially automated vehicle is moving at an instantaneous velocity, wherein the method comprises the following steps:
calculating a plurality of evasive trajectories of the vehicle with respect to a referenced collision object by combining different longitudinal accelerations with different lateral accelerations;
determining an optimal trajectory, in which a minimum distance dₘᵢₙ between the vehicle and the collision object is maximum, from the plurality of evasive trajectories;
determining a critical acceleration vector of an associated critical trajectory in which the minimum distance dₘᵢₙ reaches a near-collision limit range; and
determining a criticality of the optimal trajectory based on the critical acceleration vector and an optimal acceleration vector associated with the optimal trajectory.

2. The computer-implemented method according to claim 1, wherein the determining of the critical acceleration vector includes reducing the magnitude of the optimal acceleration vector to the critical acceleration vector, at which the minimum distance dₘᵢₙ reaches the near-collision limit range.

3. The computer-implemented method according to claim 1, wherein the criticality of the optimal trajectory is determined by forming a ratio of a magnitude of the critical acceleration vector to a magnitude of the optimal acceleration vector.

4. The computer-implemented method according to claim 1, wherein the near-collision limit range is defined by dₘᵢₙ>0 and dₘᵢₙ≤ϵ, wherein ϵ defines a near-collision distance at which a collision is just avoided.

5. The computer-implemented method according to claim 1, wherein the combining of the different longitudinal accelerations with the different lateral accelerations includes combinations of maximum usable braking capability and maximum usable steering capability according to a specified maximum friction force model including a specified circle-of-forces model.

6. The computer-implemented method according to claim 1, wherein the minimum distance dₘᵢₙ between the vehicle and the collision object is determined for each evasive trajectory and, wherein the corresponding minimum distances dₘᵢₙ of the plurality of evasive trajectories are compared with one another, and wherein the evasive trajectory of the plurality of evasive trajectories with the largest minimum distance dₘᵢₙ is selected as the optimal evasive trajectory.

7. The computer-implemented method according to claim 1, wherein an associated acceleration vector, a critical acceleration vector, and a corresponding criticality are determined for at least several of the calculated plurality of evasive trajectories.

8. The computer-implemented method according to claim 7, wherein the optimized trajectory is determined based on a comparison of the determined criticalities.

9. The computer-implemented method according to claim 1, furthermore comprising an action step:
for displaying the optimal trajectory and/or the criticality of the optimal trajector, and/or
for an autonomous or semi-autonomous adjustment of an evasive maneuver of the at least partially automated vehicle according to the optimal trajectory.

10. The computer-implemented method according to claim 1, wherein the determined criticality is used to test and/or secure an at least partially automated driving function system of the at least partially automated vehicle.

11. A computer system configured to determine a criticality of an evasive behavior of an at least partially automated vehicle, the computer system configured to:
calculate a plurality of evasive trajectories of the vehicle with respect to a referenced collision object by combining different longitudinal accelerations with different lateral accelerations;
determine an optimal trajectory, in which a minimum distance dₘᵢₙ between the vehicle and the collision object is maximum, from the plurality of evasive trajectories;
determine a critical acceleration vector of an associated critical trajectory in which the minimum distance dₘᵢₙ reaches a near-collision limit range;
determine a criticality of the optimal trajectory based on the critical acceleration vector and an optimal acceleration vector associated with the optimal trajectory.

12. A non-transitory computer-readable medium on which is stored a computer program for determining a criticality of an evasive behavior of an at least partially automated vehicle, wherein the at least partially automated vehicle is moving at an instantaneous velocity, the computer program, when executed by a computer system, causing the computer system to perform the following steps:
calculating a plurality of evasive trajectories of the vehicle with respect to a referenced collision object by combining different longitudinal accelerations with different lateral accelerations;
determining an optimal trajectory, in which a minimum distance dₘᵢₙ between the vehicle and the collision object is maximum, from the plurality of evasive trajectories;
determining a critical acceleration vector of an associated critical trajectory in which the minimum distance dₘᵢₙ reaches a near-collision limit range;
determining a criticality of the optimal trajectory based on the critical acceleration vector and an optimal acceleration vector associated with the optimal trajectory.

13. A method for configuring an at least partially automated driving function system, the method comprising:
determining a criticality of an evasive behavior of an at least partially automated vehicle, wherein the at least partially automated vehicle is moving at an instantaneous velocity, wherein the method comprises the following steps:
calculating a plurality of evasive trajectories of the vehicle with respect to a referenced collision object by combining different longitudinal accelerations with different lateral accelerations;
determining an optimal trajectory, in which a minimum distance dₘᵢₙ between the vehicle and the collision object is maximum, from the plurality of evasive trajectories;
determining a critical acceleration vector of an associated critical trajectory in which the minimum distance dₘᵢₙ reaches a near-collision limit range; and
determining the criticality of the optimal trajectory based on the critical acceleration vector and an optimal acceleration vector associated with the optimal trajectory;
wherein the determining criticality is taken into account when configuring at least partially automated driving functions including when configuring rules for evasive maneuvers.
